(19) United States
(12) Patent Application Publication
(10) Pub. No.: US 2015/0310411 A1
(43) Pub. Date: Oct. 29, 2015

(54) METHOD FOR PURCHASING OR CLAIMING A PRODUCT USING A PORTABLE COMMUNICATION DEVICE

(71) Applicant: MOBILE PAYMENT SOLUTIONS HOLDING NORDIC AB, Stockholm (SE)

(72) Inventor: Christopher LINDFELDT, Solna (SE)

(21) Appl. No.: 14/650,510

(22) PCT Filed: Nov. 19, 2013
(86) PCT No.: PCT/SE2013/051361

§ 371 Date: Jun. 8, 2015

(30) Foreign Application Priority Data
Dec. 6, 2012 (SE) 1251388-3

(51) Int. Cl. G06Q 20/20

(52) U.S. Cl. CPC G06Q 20/202

(57) ABSTRACT

Method for purchasing or claiming a product from an automated physical point of sale (100) and using a portable communication device (110), which point of sale (100) is connected to a central server (180). In the method, information is provided to the central server (180) concerning the currently available range of products at the point of sale (100). A user is provided access to a graphical user interface (401;402;403) on the device (110), enabling the user to initiate the purchase or claim at the point of sale (100). A purchase of claim request is provided from the computer software function to the central server (180). If the product is available, an instruction to make available to the user the product is provided from the central server (180) to the point of sale (100). The point of sale (100) then makes the product available to the user.

The present invention relates to a method for purchasing or claiming a product from a physical point of sale using a portable communication device.

Many propositions have been made to solve the problem of cashless purchasing. Recently, it is becoming more common to use a portable communication device, such as a mobile cell phone, for performing payments during such purchasing. This is especially true for small amount payments.

Furthermore, it is known, for instance in the field of ticket purchasing for public transport, for a user to send an SMS message, with a predefined format, conveying a payment instruction.

It is also known to use a locally installed software application or a web site to send a payment instruction, over the

Internet, to a transaction server which in turn charges the amount to a credit card or to a prepaid deposit.

WO 2005/029431 describes a method for paying for purchased products by sending an SMS, whereby an account of the buyer is charged for the payment.

U.S. 2007/0255653 A1 describes a method for effecting mobile payments using a variety of different channels, among which SMS messages are one.

Such methods are often perceived by the user as complicated.

It would be especially desirable to provide a simple and highly available way to purchase products at unattended points of sale, where there is no possibility of communication with service personnel, and where the user only has his or her portable communication device, such as a mobile telephone, to use to effect the payment.

Furthermore, it would be desirable for a first party to be able to give or provide access to a second party of a certain predefined product, possibly at a certain predefined time.

For instance, a parent may want to make it possible for a child to pick up a fruit at a vending machine, but not a soft drink; or a company may as a promotion want to give a certain product to a customer free of charge, for pickup at a conveniently located vending machine.

Moreover, a selling or providing party, such as a vending machine operator, may want to dynamically control availability and/or pricing of products available to users, depending for instance on the time of day, location of the machine or the type of user.

The present invention solves these problems in that it provides a more convenient method for allowing a user to purchase or claim a certain product at a point of sale, which also provides more detailed control for a providing party.

Hence, the present invention relates to a method for purchasing or claiming a product from an automated physical point of sale and using a portable communication device, which point of sale is connected to a central server, the functionality of which central server may be distributed at different locations, characterised in that the method comprises the steps of a) providing to the central server information concerning the currently available range of products at the point of sale; b) causing a computer software function to provide a user of the portable communication device access to a graphical user interface on a screen of the said device, which interface enables the user to initiate the purchase or claim of at least one product at the point of sale; c) providing from the computer software function to the central server a request to purchase or claim at least one certain product from the point of sale; d) if the at least one certain product is currently available at the point of sale, providing from the central server to the point of sale an instruction to make available to the portable device user the at least one certain product; and e) causing the point of sale to make the at least one certain product available to the portable device user as a response to the said instruction.

In the following, the invention will be described in detail, partly with reference to the appended drawings, in which:

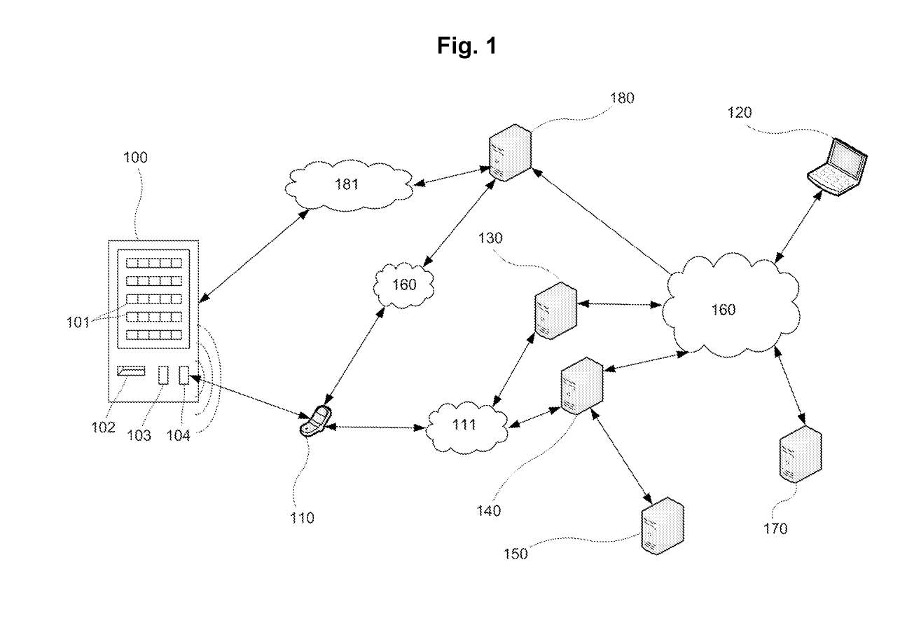

FIG. 1 is an overview illustration of a system for performing a method according to the present invention;

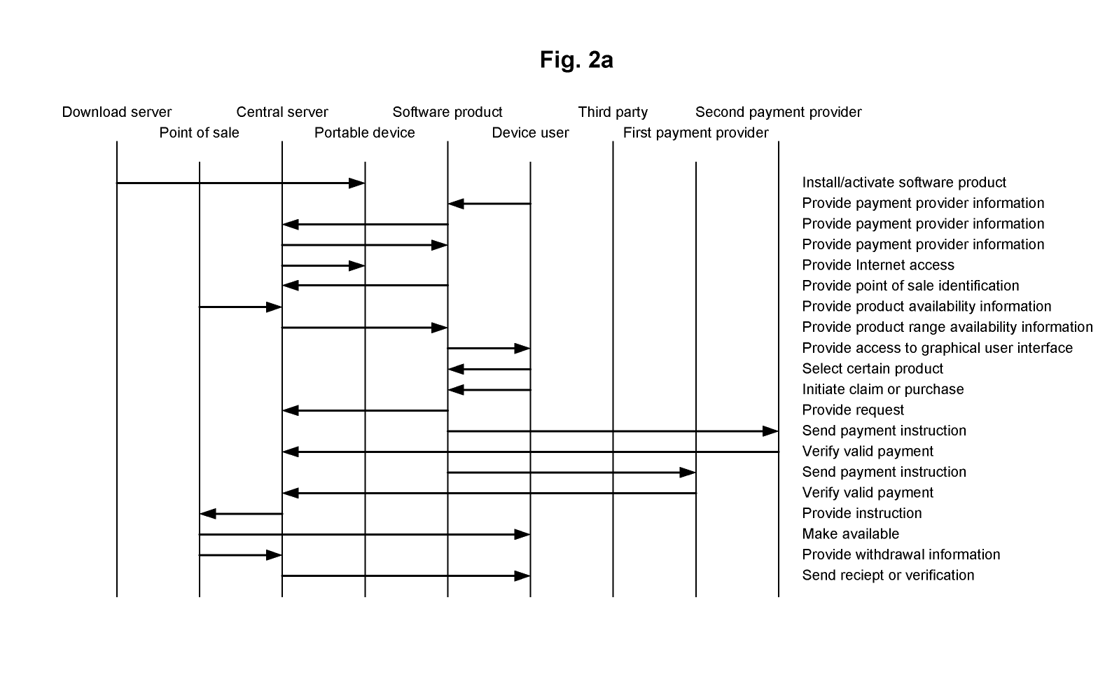

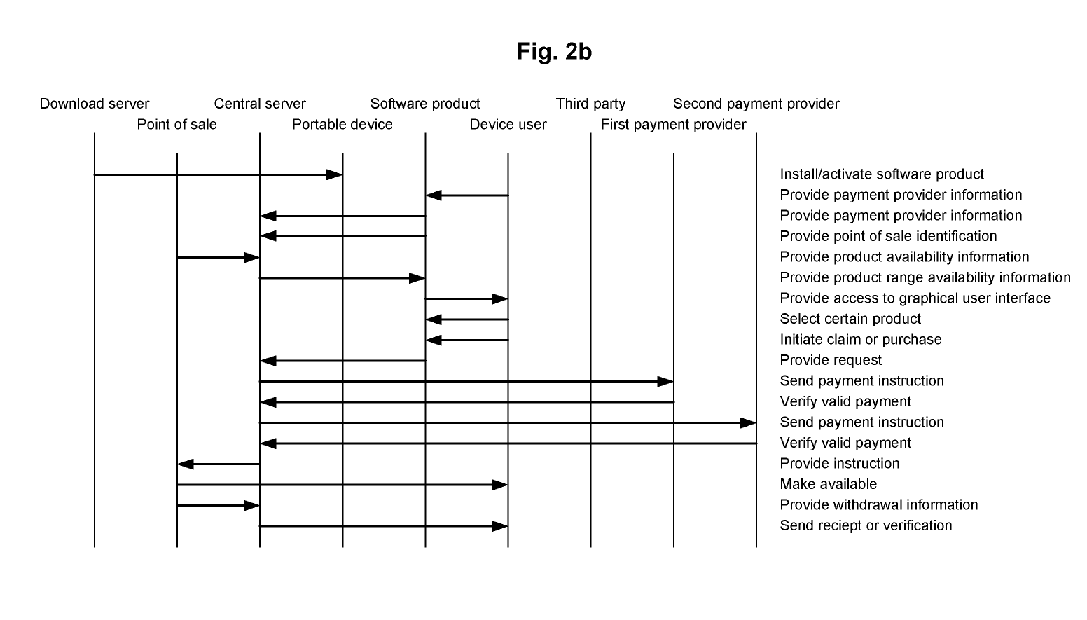

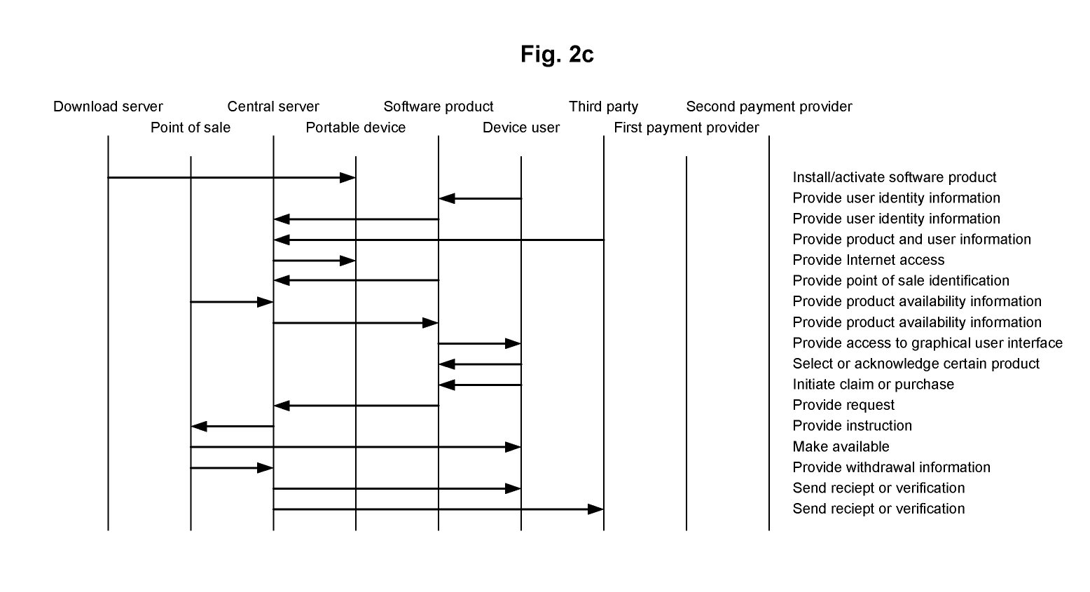

FIGS. 2a-2c are respective time line diagrams illustrating methods according to a first, a second and a third exemplary embodiment of the present invention, respectively;

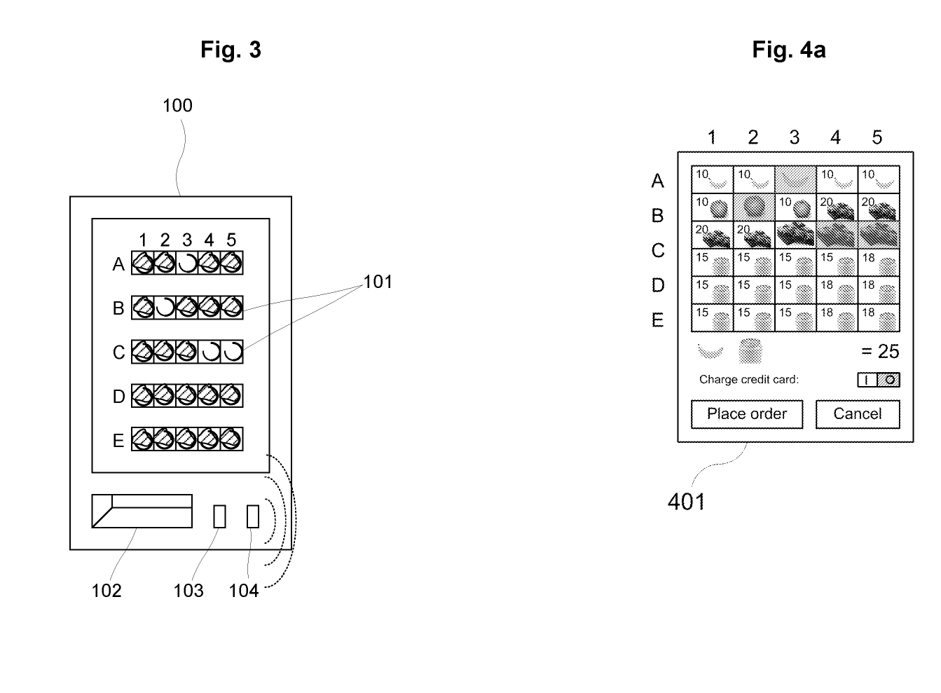

FIG. 3 is a detail view of the vending machine shown in FIG. 1;

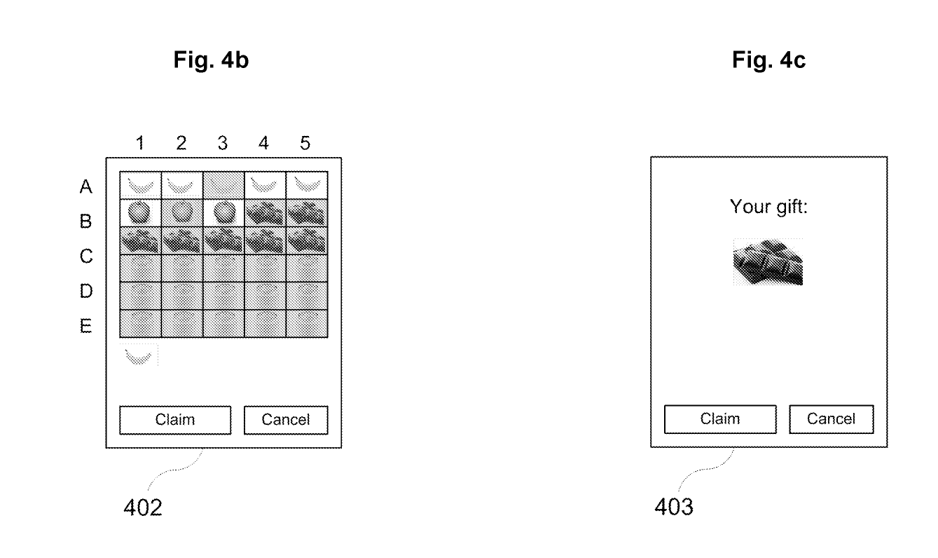

FIGS. 4a-4c show respective graphical user interfaces according to a first, a second and a third exemplary embodiment according to the invention, respectively; and

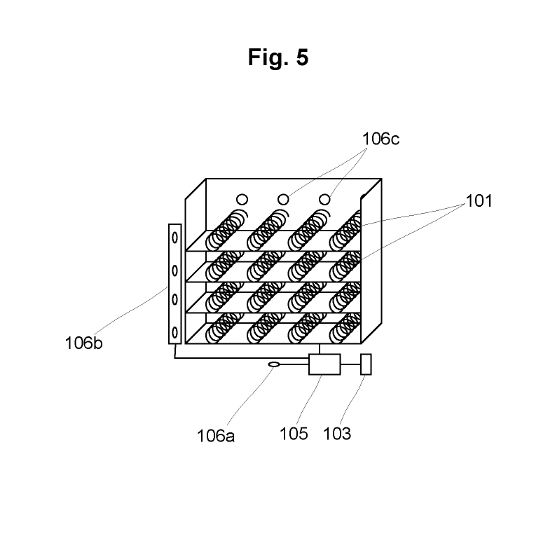

FIG. 5 is a detail view of a vending machine point of sale according to the invention.

Hence, FIG. 1 illustrates a system suitable for performing a method according to the present invention.

A point of sale 100 is illustrated by way of example as a vending machine, comprising product compartments 101 in which different products for sale are viewable to the user, and a GSM module 102 for communicating via SMS messages. The compartments 101 may for instance be conventional spiral equipped compartments. It is preferred that each such compartment 101 holds zero or more products of at the most one single product type for each compartment.

The point of sale 100 is a physical point of sale, such as a vending machine, an automated retail kiosk, the counter of a shop or the cashier of a ticket vendor. The point of sale 100 has a wired or a non-wired access to a wide area network such as the Internet, for instance via a mobile phone network such as a GSM network 181. In FIG. 1, the said Internet access is provided via a mobile telephony network, using GPRS (General Packet Radio Service) and a vending machine GSM module 103, or a corresponding mobile wireless network such as 4G. The point of sale 100 is connected, via network 181, to a server 180.

In particular, it is preferred that the point of sale 100 is a physical unattended point of sale, in other words it is a fully automated purchasing station without any sales staff being physically present during the purchase. In this case, the invention provides a simple way for a user to purchase or claim products from the point of sale 100, using a wide range of payment or crediting options and without having to enter into a dialog with such sales staff. In the following, the invention is described in terms of a vending machine being the point of sale 100, but it is realized that the invention is analogously applicable to other physical types of point of sales, as exemplified above.

The server 180 may be located at one physical location, but the functionality of server 180 may however also be distributed at different locations, using several interconnected computer servers. For instance, billing, messaging and inventory management functions may be implemented at different locations.

A portable communication device 110, such as a mobile telephone featuring a general-purpose programmable operating system, is preferably carried by the user, such as a claimer or purchaser, to within geographic proximity of the point of sale 100 from which the user wants to purchase or claim one or several products. The communication device 110 is connected to a mobile phone network 111, such as a GSM network, provided by the user's mobile phone operator.

Two SMS recipients 130, 140, in other words servers capable of receiving SMS message data delivered in the mobile phone network, are connected to the network 111. SMS recipient 140 is in turn connected, for instance via a LAN or the like, to a telephone bill handling system 150.

SMS recipients 130, 140, as well as an external bank account handling server 170 and a vending machine management server 180, are connected to each other over a wide area network 160, such as the Internet, which may or may not be the same as network 181. The device 110, in particular a computer software function operable thereon (see below), is also in contact with server 180 via the wide area network 160. Alternatively, the device 110 may be connected via GSM network 111, or via a WiFi connection provided by the point of sale 100, via network 181 (see below).

According to the invention, a user arrives at the point of sale 100 with the intention to either purchase or claim one or several products, or both. In either case, the purchase or claim will be made using the device 110. Furthermore, in the case of a purchase, the user intends to pay for said products using the device 110, preferably using a predefined payment channel set up for use with the device 110. In the case of a claim, the user intends to pick up one or several products previously credited to the user or for which a third party has agreed to pay. The authenticity of such claim will be verified using the device 110. In the following, various exemplary embodiments of both of these two main alternatives will be described.

According to the invention, the server 180 is first provided, preferably from the point of sale 100, with information concerning the currently available range of products at the point of sale 100. Such information preferably includes all currently carried product types and respective quantities. The information is preferably sent over the network 181, and may be on any suitable digital format. However, it would also be possible, although not preferred, for personnel refilling the point of sale 100 with products to provide server 180 with for instance a manual report of the current inventory in the point of sale 100 after refill. What is important is that the server 180 has valid and up to date information about the currently available range of products at the point of sale 100 when the user is about to initiate the purchase or claim. Also, in applicable cases it is preferred that the point of sale provides the server 180 with information regarding at what type of product that is stored at each inventory position, such as in which spiral, at the point of sale 100.

According to a preferred embodiment, the point of sale 100 comprises automatic product inventory sensing means, arranged to sense a presence of a product of at least one product type, preferably all available product types, at the point of sale, preferably also a present quantity of products of such at least one product type, preferably all available product types. The said sensing means are preferably connected to a central computing unit at the point of sale, which unit is in turn connected to the wireless communication unit 103.

The sensing means may for instance be embodied as a counter or a product presence sensor connected to one or several of the respective product compartments 101 at the point of sale 100, in which case a certain compartment is predetermined to carry products of a certain product type.

FIG. 5 illustrates an alternative, preferred embodiment, in a detail view over, among other things, the compartments 101 and GSM module 103 of the vending machine 100 illustrated in FIG. 3. A central processing unit 105 is connected to at least one optical sensing unit 106a-106c. The optical sensing units can be arranged to read for instance a barcode on a product being inserted into, or withdrawn from, a certain compartment, and then the unit 105 may be arranged to keep count of all insertions and withdrawals. However, it is preferred that the units 106a-106c are in the form of at least one camera, arranged to electronically provide an optical image of at least part of the planogram of the vending machine 100 to the unit 105, which in turn is arranged to receive the image and map it against a database holding digital image data of a set of predefined products in order to automatically detect the presence of products using image analysis. Such image analysis may be conventional per se, and may for instance be based upon the detection of certain graphical markers fixedly arranged on or in connection to individual compartments or to the planogram, and/or of graphical markers on the products themselves; on the automatic identification of barcodes on the products; and/or on the visual comparison of each product with a predefined visual general appearance of different product types.

If the visual identification is not 100% successful, a manual reading and reporting of service personnel on site may be used as a supplement when so is needed. Another alternative is that the central processing unit 105 is arranged to, for instance via GSM module 103, send the image or images to the server 180, where an automatic or semiautomatic identification of the products can be achieved. This way, the vending machine 100 may be filled with many different product types.

FIG. 5 illustrates three alternative or supplementary placements of the cameras 106a-c: a fish eyed lens camera 106a positioned below the planogram viewing all compartments; a set 106b of cameras, each viewing a respective row of compartments; and individual cameras 106c located above each respective compartment and viewing this compartment only.

Thereafter, a computer software function is arranged to provide the user of the portable communication device 110 access to a graphical user interface 401, 402, 403 (see FIGS. 4a-4c) on a screen of the said device 110, which interface enables the user to initiate the purchase or claim of at least one product at the point of sale 100. The said interface may or may not comprise information based upon information concerning the currently available range of products at the point of sale, as provided to the device 110 from the server 180. For instance, if the user is allowed to select one or several specific products via the user interface, only products actually available at the vending machine 100 may be shown to the user in the interface. Furthermore, if the user has received a specific type of product from a third party, such as a chocolate bar of a certain brand, the interface may only allow the user to claim such product if it is actually available at the vending machine 100. On the other hand, the product availability may be checked only by the server before making a product available to the user (see below). In this case, it is not strictly necessary for the interface to take product availability into consideration, but can for example show a standardized range of products to the user.

In a subsequent step, a request is provided, from the portable communication device 110 to the central server 180, to purchase or claim at least one certain product from the point of sale 100. The request is sent over network 160, on a predefined format, and preferably comprises the identity of the at least one certain product. The certain product is preferably one that has been selected or accepted by the user via the interface 401, 402, 403, and for which the said purchase or claim has been initiated in the previous step.

Upon the receipt of said request, the central server 180 is arranged to check the availability of the requested product or products against the product range availability information previously received from the vending machine 100. If the at least one requested product is currently available at the point of sale 100, the server 180 is arranged to provide to the point of sale 100 an instruction to make available to the portable device user the said at least one product. If only a subset of several requested products is available, the server 180 may send an instruction to the point of sale 100 to make those products available to the user. The instructions are sent, in a way which is conventional as such, via network 181.

In response to the said instruction sent from the server 180, the point of sale 100 is then arranged to make the said at least one requested product available to the portable device user. Typically, this entails activating a product dispensing means, such as a conventional vending machine spiral holding products of the requested type, using an electrical motor or the like, so that said product or products are displaced for pickup by the user through a product pickup door 102 or the like. It is realized that the product or products may be delivered to a user in other ways, such as electronically or at a later point in time. What is important is that the user is within physical proximity of the point of sale 100 during the purchase or claim procedure, such that the purchase or claim effectively and physically takes place at the point of sale 100 but using the portable communication device 110.

Such a method is associated with a number of advantages.

Firstly, a shopping experience similar to that in a staffed shop can be achieved for the user, via a graphical user interface on the user's mobile phone handling both the presentation, selection and, via server 180, distribution of products. The products presented to the user in the interface can be relevant to the actual situation, since the server 180 is aware of the current product availability at the point of sale 100. The graphical user interface presented on the device 110 also provides a generally more flexible and powerful way of marketing the available products, since such a graphical user interface is generally more easily and dynamically modifiable than the user interface of for instance a vending machine.

According to one exemplary preferred embodiment, the product representation in the graphical user interface can be enriched with additional product-related information received from the server 180, such as nutritional and allergy information, carbon footprint, size and weight information, and so on. Such information can be presented in the form of a web link and/or information displayed in connection to the product on the screen of the device 110. Such information is often difficult to take part of for a user of for example a conventional vending machine, even if the physical products are displayed in a planogram through a window.

The conventional way to purchase products at an unattended point of sale is for the user to first provide payment, such as using coins or a credit card, and thereafter to select one or several products. Using a method according to the present invention, the user may instead act as is more customary at staffed points of sale, that is first to select products and then to pay the total amount due. Payment can take place in various ways, as described below.

Furthermore, one and the same graphical user interface may be used with several different types of points of sale. This way, the user does not have to bother about dealing with varying types of user interfaces on, for instance, different vending machines.

Also, since the purchase or claim is handled via server 180, the seller, vending machine operator etc. achieves precise and detailed control over the purchase or claim, at least so that product availability can be made different to for instance different users or at different times. This will be detailed in the following.

FIG. 2a shows a method according to a first exemplary embodiment according to the invention, in which time runs from the top down in the chart.

In an initial step, a computer software function is installed and/or activated on the device 110. This may, for instance, be by installing a client software product on the device 110 from a download server, or by providing access to an interactive Internet page. In the latter case, all or some of the information used by the software function is thus stored at a different location than on the device 110. The installation and/or activation may incorporate signing up for a user account with associated username and password, and other steps which are conventional as such. When this step is finished, the user may open the graphical user interface from the device 110 at will.

In connection to the installation/activation, or in a preceding or subsequent step, the user may supply information regarding desired payment providers that the user wants to use for a purchase. Such information is preferably supplied only once and used for several purchases, and may comprise respective payment provider identification information and possibly also respective user credential information for carrying out a payment with said payment providers on behalf of the user. Such information about at least one, preferably at least two payment providers is preferably supplied by the user to the computer software function, which in turn sends the said information to the server 180. It is preferred that all credential communication, preferably all communication between the software function and the server 180, is encrypted.

The user may also provide the said payment provider- and credential information to the server 180 using another channel, such as using an Internet browser on another computer or by regular mail. In any case, it is preferred that the user is presented with a list of possible payment providers, with which providers the central server 180 operator has a previous agreement.

Preferably, one of the available payment providers is a mobile phone network operator to which the device 110 is a subscriber via a SIM (Subscriber Identity Module) card in the device 110. It is preferred that the user may choose not to provide information regarding any payment provider. In this case, the said network operator is used as a default payment provider, according to the procedure for billing the user's telephone bill described below.

After verifying the availability of the selected service providers and any credential information, the server 180 supplies information to the software function about available payment providers.

When the user arrives at the point of sale 100 in order to do a purchase, the point of sale 100 may provide wireless Internet connectivity to the device 110 before and during the purchase, via a WiFi provider module 104 at the point of sale 100. This way, the device 110 can communicate with the server 180 using said Internet connectivity. Since the point of sale 100 has an Internet connection via network 181, the Internet connectivity needed by the software function for communication with server 180 can be provided by the point of sale 100 itself. This is especially advantageous when the device 110 is roaming, since costs for data traffic in such cases can be considerable.

At the latest at this point, but preferably continuously or at least every time a product enters or leaves the point of sale 100 by a purchase, claim or refill, the point of sale 100 provides to the server 180 the above described information regarding product range availability at the point of sale 100.

As the user opens or initiates the computer software function on the device 110 in order to begin the purchasing process, the specific point of sale 100 at which the user intends to do the purchase is first identified. This may for instance be made by the user typing in an identification code of the machine, by automatic identification using a positioning service such as GPS (Global Positioning System), or in any other suitable way. The software function then provides the server 180 with information regarding the identity of the point of sale 100 to be used.

According to a preferred embodiment, the identification takes place by the user bringing the device 110 into physical proximity of the point of sale 100, whereby information is transferred to the device 110 from the point of sale 100 identifying, directly or indirectly, the point of sale 100. An example is the user using a camera of the device 110 to scan a bar- or QR code which identifies the specific point of sale 100. It is furthermore preferred that the reception by the device 110 of the information from the point of sale 100 also automatically initiates the software product so as to make it ready for a purchase or a claim at the identified point of sale 100. This may for instance take place by the reading of a QR code automatically directing a web browser of the device 110 to a web page, or associating a locally installed application to a web service, using which the purchase or claim can be made from the identified point of sale 100 using the graphical user interface according to the invention. Another example is that the device 110 is arranged to, upon entering into the coverage area of a WiFi connection provided by the point of sale 100, the graphical user interface is automatically displayed on the device 110 with the correct point of sale 100, as identified via the WiFi network.

Thus, using the device the user can conveniently and quickly check in at the point of sale 100, and immediately start the purchase or claim procedure.

Then, the server 180 provides to the device 110 information concerning the current product range, and preferably also pricing information regarding the said product range, based upon inventory information provided from the point of sale 100 as described above. Based on the information from the server 180, the software function is then arranged to, via the graphical user interface on device 110, present information regarding the currently available product range and preferably also pricing at the identified point of sale 100.

An example of such a graphical user interface 401 is shown in FIG. 4a, which interface 401 is presented to a user wanting to purchase a product from the exemplary vending machine point of sale 100 shown in FIG. 3 (sharing reference numerals with FIG. 1). For ease of reference, the twenty-five compartments 101 of the machine 100 are labeled using a coordinate system A . . . E (Y axis) and 1 . . . 5 (X axis). The corresponding coordinate system is used in FIGS. 4a-4c.

In the product range availability information step described above, the machine 100 provided the server 180 with information about what type of products (bananas, apples, chocolate bars and sodas) are stored in which compartments 101, and the fact that compartments A3, B2, C4 and C5 are currently empty in the machine 100. This information is then presented graphically to the user in the user interface 401.

According to a preferred embodiment, the point of sale 100 comprises a viewing window, such as a locked glass door, through which the user can view the compartments 101 and hence also the currently available range of products. In this case, information is provided to server 180 and then further to the computer software function concerning the physical position in the said viewing window of the available products, in other words which compartment holds which product type. The graphical user interface 401 in turn comprises a graphical view of the currently available products arranged in the graphical view in a way, such as the type of grid shown in FIG. 4a, corresponding to the said information concerning the actual physical positions in the viewing window of the available products (planogram). This way, the user can select one or several products to purchase by selecting them directly in said graphical view, such as by pointing to them using touch-screen technology in the device 110. In FIG. 4a, the user has selected a banana and a soda can, to a total cost of 25 SEK (shown below grid).

Hence, via the graphical user interface the user is exposed to a virtual representation of the vending machine 100, so that the user may pick and choose among the displayed products by selecting the corresponding product in the interface. This is particularly easy for the user.

The compartments A3, B2, C4 and C5, being empty in the machine 100, are grayed out in the corresponding locations in the grid of the graphical user interface, and not available for selection.

It is in some cases preferred that at least one of the currently available products is not selectable for the user in the graphical user interface if a certain predetermined criterion is not fulfilled. Apart from the corresponding compartment 101 being empty in the machine 100, the criterion may be based on a purchase specific parameter selected among the group consisting of point of sale identity or location;

user identity, category or type; current time, weekday or date; and the existence of a certain special promotion. This way, the vending machine operator may provide a different selection to different customers, at different times, etc. The criterion may also be based upon a payment provider to be used for the purchase, which payment provider is then known to the computer software function before presenting the interface to the user, either by user selection or by automatic selection as described below. Certain types of products may be eligible for using different sources of financing, and this way such need can easily be met.

According to a preferred embodiment, the point of sale 100 does not display any prices for at least some products in the currently available range of products. Instead, the graphical user interface provides price information for such products (as shown in the grid of FIG. 4a by price information in each respective grid location next to an image of the product). This is advantageous since the vending machine operator can then easily present different price information to different customers, at different times, etc.

Like product selectability, the price displayed to the user in the graphical user interface 401 is preferably based on a purchase specific parameter selected among the group consisting of point of sale identity or location; user identity, category or type; current time, weekday or date; the existence of a certain special promotion; and a payment provider to be used for the purchase. For instance, previous customer loyalty can be awarded with lower pricing for certain products.

According to a preferred embodiment, the device 110 comprises a camera, preferably a video camera. In this case, the computer software function is arranged to activate said camera, and display what is being filmed by the camera on the display of the device 110 instead of, or in addition to, the above described grid. Then, the software function comprises image recognition means able to identify the location in the filmed images of the point of sale 100, and its compartments 101. Such image recognition means are conventional as such, and may for instance recognize predefined visual markers physically arranged on the vending machine 100. The software function is then arranged to overlay other information, such as the grayed out compartments and pricing information as described above, on top of the filmed images, and the user can select products by for instance pointing to them on the display.

Hence, the user interface allows the user to, using device 110, select one or several products to purchase from the vending machine 100. Once the selection of one or several products is made, the user initiates the purchase itself by pressing the button “Place order”, and a purchase request is sent from the software function to the server 180, at least comprising information identifying the product or products selected by the user.

In the preferred case that information concerning at least two payment providers is at this point available to the computer software function, a certain one of these payment service providers is selected by the computer software function, or by the central server upon request by the computer software function, in order to execute payment for the selected product before an instruction is sent to the vending machine 100 to make the product or products available to the user.

Which payment provider to use can be selected by the user. For instance, in interface 401 the user may choose to charge a predetermined credit card, using previously supplied and store credential data, by toggling the corresponding control. If the credit card is not to be charged, the user's telephone bill may instead be charged.

According to one preferred embodiment, one payment provider is automatically selected from at least two predetermined payment providers, based upon at least one purchase specific parameter selected among the group consisting of point of sale identity or location; user identity, category or type; current time, weekday or date; and the existence of a certain special promotion. For instance, an employee may be entitled to a fruit free of charge from vending machines located at office premises, but will have to pay for other types of products than fruit or for all products when not at said office premises. Further, the employee may not be entitled to free fruit during the weekends even if at the office. This can be automatically accomplished by the software function automatically selecting a payment provider charging an account held by the employer for free of charge purchases of fruit, and a payment provider charging an account held by the employee for all other purchases.

According to one preferred embodiment, payment for the product or products is effected by one of at least one, preferably at least two, preregistered payment providers by sending a payment instruction to the payment provider in question in the form of an SMS (Short Message Service), which is automatically produced using a predetermined text format by the computer software function and then sent by the computer software function from the portable communication device 110 to a certain SMS recipients 130, 140 corresponding to the payment provider in question, over the mobile phone network 111 to which the portable communication device 110 is connected.

The sending of the said SMS is preferably done by simply sending the SMS message to the telephone number associated with the selected SMS recipient, via the normal SMS channel over the mobile phone network 111, for instance using the native SMS client of the device 110.

The information provided about payment providers from the server 180 to the computer software function may comprise information about the telephone number and text message format to be used for one or several payment providers, and which payment provider that is to be used.

The SMS message comprises information regarding the selected product or products, and preferably also information comprising at least the total payment amount. Alternatively, the SMS message can comprise information identifying one or several of the products to be purchased, in which case the payment amount is determined centrally, for instance by server 180. The SMS message may in this case also comprise information identifying the point of sale 100.

According to the invention, the SMS message is sent from the portable communication device 110, via the mobile phone network 111, to an SMS recipient arranged to interpret SMS messages of the above described type.

Further, the SMS recipient to which the SMS message is sent is arranged to cause the payment to be executed, in other words the SMS recipient is directly or indirectly, via possibly a server such as server 180 and a connected payment service provider, arranged to provide for the payment in question to be carried out. That the SMS recipients are arranged to “cause the payment to be executed” is herein hence not intended to mean that the SMS recipient as such necessarily directly takes care of the payment. Rather, not least since an SMS recipient of the type described herein may be an integral part of an operator's mobile network hardware, the SMS recipient is arranged to act upon the reception of an SMS message in a way which ultimately leads to the payment of the amount. What is important is that the payment is carried out in different ways as a consequence of the reception of SMS messages of at least two different SMS recipients.

Furthermore, the computer software function is capable of selectively sending the SMS message to one of the at least two such SMS recipients 130, 140, which are preferably associated with different respective telephone numbers for receiving SMS messages.

According to the invention, the first SMS recipient 140 is arranged to, upon receipt of the SMS message, cause the payment amount to be charged via a first payment service provider, such as the telephone bill handling system 150. The second SMS recipient 130 is, however, arranged to, upon receipt of the SMS message, cause the payment amount to instead be charged via a second payment service provider, such as the external bank account handling server 170, which then executes the payment for instance by charging a credit or debit card (using for instance a so called securely stored card for recurring payment), or a bank account, associated with the user. Herein, these types of cards and accounts are collectively denoted “bank accounts”, which term is intended to cover all types of financial arrangements capable of being charged for a purchase, such as debit and credit cards as well as deposit accounts. As an alternative, a conventional invoice may be sent to a paying party. According to the invention, the second payment provider is different from the first payment provider.

According to a preferred embodiment, at least one 140 of the SMS recipients is arranged to, upon receipt of the said SMS message, cause the payment amount to be charged to the telephone subscription used for sending the SMS message. Hence, if the SMS message is sent to SMS recipient 140, the purchase amount, together with any service charges, will be charged to the mobile telephony bill of the user of device 110.

Moreover, according to a preferred embodiment, at least one 130 of the SMS recipients is arranged to, upon receipt of the SMS message, cause an amount to instead be charged to a predetermined bank account.

According to a preferred embodiment, a payment confirmation is thereafter communicated to the server 180 if the payment was validly executed by SMS recipient 130 or 140, and the server 180 is arranged only to instruct the machine 100 to make the product or products available to the user after such payment confirmation has been received.

In this context, it is preferred that the payment instruction sent to the SMS recipient 130 or 140, and also the verification sent from the payment provider to the server 180, comprises information identifying the at least one purchased and validly paid for product, and that it is the payment provider which communicates to the server 180 the information identifying the selected product after the payment has been validly executed. In other words, the provision of the information identifying the purchased product or products takes place via the payment provider, together with a message verifying the valid payment of the product or products.

This is illustrated in FIG. 2a, wherein a payment instruction is sent to either a first or a second payment provider, which then sends the payment verification message to the server 180 if the payment was validly executed.

Thereafter, the server 180 provides an instruction to the machine 100 to make available to the user the banana and the soda, upon which the machine 100 activates the corresponding spirals A1, D3, making available the products to the user via opening 102.

Also, a confirmation, such as a receipt or a verification, is preferably sent to the user from the central server 180, for instance in the form of an SMS or an e-mail.

It is preferred that the point of sale 100, after the dispatching of said product or products, provides to the server 180 information concerning the withdrawal of the purchased product or products from the point of sale 100. In response hereto, the server 180 updates its current view of the available range of products at the point of sale 100.

FIG. 2b illustrates an alternative method according to the present invention, in the form of a time line diagram which is similar to the one shown in FIG. 2a. For reasons of brevity, only differences between FIGS. 2a and 2b will be described in the following.

According to this embodiment, before approaching the point of sale, the user has provided, via the computer software function or in any other way as described above, the server 180 with credential information for carrying out a payment with at least one, preferably two, different payment providers on behalf of the user. However, no information is necessarily provided to the computer software function regarding the payment service providers.

Instead, in response to the purchase request sent from the computer software function to the server 180, comprising information identifying the product or products to be purchased, the server 180 itself causes a payment covering the said product or products to be executed before the instruction to make it or them available to the user is sent.

This is performed by the server 180 sending a payment instruction, in a way which is conventional as such using for instance a secure digital communication channel over the Internet, to one of at least one, preferably at least two, payment providers. The selection of payment provider can be made based upon selection criteria similar to the ones described above for selecting payment providers.

If a positive payment verification is received from the payment provider, the server 180 then instructs the machine 100 to provide the product or products to the user.

It is noted that in the exemplary embodiment shown in FIG. 2, no Internet access is provided by the machine 100 to the device 110. Instead, the device 110 uses the network 111 for Internet connectivity. However, the machine 100 could provide Internet access also in this case.

FIG. 2c, which is also similar to FIG. 2a, illustrates a third exemplary embodiment of the present invention, in which a user, rather than purchasing a product and paying for it, claims one or several products previously credited to the user as a gift or the like. Again, only differences as compared to FIG. 2a are described.

After the step of installing/activating the software product, an identity of the portable device 110 user is made known to the computer software function. The identity is selected to identify the user in a way so that the server 180 can compare the identity to information available to the server 180 and this way identify a user based on said identity, and can comprise an MSISDN of the device 110, a user name, a unique code, or any other suitable means of identification. The computer software function is then arranged to provide information to the central server regarding the said user identity.

In this case, no payment provider information needs to be supplied, since no payment will be made from the user. However, such payment provider information could of course be supplied if the user wishes to both purchase and claim products.

In a step carried out before the user initiates the claim at the vending machine 100, information is sent from a third party 120 (see FIG. 1), via the Internet 160, to the server 180, identifying at least one product or product category which the user will be able to claim and also information identifying the user him- or herself. The third party may for instance be a company wanting to give the user a certain product for free as a part of a special promotion; a parent wanting to provide a fruit to a child; a person wanting to give a soda or a chocolate bar to a friend; etc. The third party may pay for the said gift in any suitable manner, and the valid claim is then stored at the server 180 for future use.

According to one preferred embodiment, the sender agrees to pay for a certain maximum number of products or for products up to a certain maximum total cost. As the user claims one or several products, these may for instance be charged against a previously setup billing arrangement between the third party 120 and the central server 180. If the user tries to claim more products than what has been allowed by the third party 120, the central server 180 will not accept this.

The server 180 may provide the computer software function with information regarding the complete range of products available at the machine 100, possibly including prices. However, it would be sufficient in many cases instead for the server 180 to provide the computer software function with information regarding the availability of the said at least one product or product category at the vending machine 100.

The graphical user interface presented to the user may then, for example, look like the one 402 shown in FIG. 4b or the one 403 shown in FIG. 4c.

In both of these cases, the interface allows the user to initiate the claim of the at least one product or product category if the user has been identified as a user entitled to such a claim based upon the user identity information sent from the computer software function to the sever 180, and if the at least one product is available at the point of sale.

In the case of interface 402, only fruit products (product category “fruits” comprising bananas and apples) are available for selection. In the case of interface 403, only a specific type of chocolate bar is available. In the latter case, the user may only acknowledge the chocolate bar rather than select a product. After selection or acknowledgement, the user selects “Claim”, and the request is sent to the server 180 in a way which corresponds to the above described. Since the claimed product or products are prepaid by the third party, or are free of charge, no payment provider needs to be contacted.

Towards the end of the method embodiment illustrated in figure 2c, a confirmation, such as a receipt or verification, is sent both to the device 110 user and to the third party 120. In many cases, it is sufficient or even preferred if only the third party 120 receives the confirmation. For example, the sender of a gift may want to know that the gift has been claimed by the recipient, but the recipient may not have any use for a confirmation since no payment was made.

Above, preferred embodiments have been described. However, it is obvious to the skilled person that many modifications may be made to the described embodiments without departing from the basic idea of the invention.

For example, other types of graphical user interfaces than the ones described above may be used. For instance, the user interface can be arranged to be activated with a question to a user whether a product is to be claimed free of charge in reaction to the user coming into sufficient proximity of a vending machine carrying such products.

Furthermore, the graphical user interface can be put to interactive use, in the sense that the user can be provided with a possibility to affect the product range using the user interface. For instance, when the graphical user interface is shown on the device 110, the interface may allow the user to select one or several desired product types which the user would like to be able to purchase at the point of sale 100. This can take place via a simple selection interface, such as a conventional drop-down text box; the user may be able to drag-and-drop products to empty product compartments in the interface; or in any other suitable way. For instance, all users of a certain point of sale, such as an on-work vending machine, may be able to vote for products using the graphical user interface for that specific vending machine, and when the vending machine is refilled, more voted for products may be supplied in order of priority before less voted for products.

Thus, the invention is not limited to the described embodiments, but may be varied within the scope of the enclosed claims.

1-11. (canceled)

12. Method for purchasing or claiming a product from an automated physical point of sale (100) and using a portable communication device (110), which point of sale (100) is connected to a central server (180), the functionality of which central server (180) may be distributed at different locations, which point of sale (100) is identified when a user of the portable communication device (110) has arrived at the point of sale (100), with the device (110), and wherein information regarding the identity of the point of sale (100) is communicated to the central server (180) by a computer software function running on or accessible from the portable communication device (110), wherein the method comprises the steps of
a) providing, from the point of sale (100) to the central server (180), information concerning the currently available range of products at the point of sale (100);
b) providing from the central server (180) to the computer software function information regarding the currently available range of products at the point of sale (100);
c) causing the computer software function to provide a user of the portable communication device (110) access to a graphical user interface (401;402;403) on a screen of the device (110), which interface (401;402;403) presents information regarding the currently available range of products at the point of sale (100), and enables the user to select and initiate the purchase or claim of at least one product at the point of sale (100);
d) providing from the computer software function to the central server (180) a request to purchase or claim at least one certain product from the point of sale (100);
e) providing from the central server (180) to the point of sale (100) an instruction to make available to the user of the portable device (110) the at least one certain product; and
f) causing the point of sale (100) to make the at least one certain product available to the user of the portable device (110) as a response to the instruction.

13. Method according to claim 12, wherein an identity of the user of the portable device (110) is made known to the computer software function, and the computer software function provides information to the central server (180) regarding the user identity.

14. Method according to claim 13, wherein, in a step carried out before step c), information identifying a user is provided to the central server (180), and, in step c), the graphical user interface (401;402;403) is caused to allow the user of the portable device (110) to initiate the claim or purchase of the at least one product if the user of the portable device (110) is identified by said sent information and if the at least one product is available at the point of sale (100).

15. Method according to claim 12, wherein the method further comprises, in step b), providing from the central server (180) to the computer software function pricing information regarding the product range; in step c), the graphical user interface (401;402) presents information regarding the currently available product range and pricing at the point of sale (100) and allows the user to select one or several products to purchase or claim from the point of sale (100); the at least one certain product is a product thus selected; and the request provided in step d) comprises information identifying the at least one product.

16. Method according to claim 15, wherein the point of sale (100) comprises a viewing window through which the user can view the currently available range of products; in said product range information step, information concerning the physical position in the viewing window of the available products is also provided to the computer software function; and the graphical user interface (401;402) comprises a graphical view of the currently available products arranged in the graphical view in a way corresponding to the information concerning the physical positions in the viewing window of the available products, so that the user can select one or several products to purchase by selecting them in said graphical view.

17. Method according to claim 15, wherein the point of sale (100) does not display any prices for at least some products in the currently available range of products, and the graphical user interface (401;402) instead provides price information for such products.

18. Method according to claim 12, wherein, in an initial step, the user has provided the central server (180) with credential information for carrying out a payment with a first payment provider (130,140) on behalf of the user, and the central server (180) in the response to the information identifying the at least one certain product received in step c) causes a payment covering the at least one certain product to be executed before step e) is carried out.

19. Method according to claim 12, wherein, in step d), a payment instruction on covering the at least one certain product is sent by the computer software function to a second payment provider (130,140), based upon information concerning the second payment provider (130,140) provided to the computer software function in a previous step; a payment confirmation thereafter is communicated to the central server (180) if the payment was validly executed; and the central server (180) only executes step e) after such payment confirmation has been received by the central server (180).

20. Method according to claim 12, wherein at least one of the currently available products is not selectable for the user in the graphical user interface (401;402) if a certain predetermined criterion is not fulfilled, which criterion is based on a purchase specific parameter selected among the group consisting of identity or location of the point of sale (100); user identity, category or type; current time, weekday or date; the existence of a certain special promotion; and a payment provider (130,140) to be used for the purchase.

21. Method according to claim 12, wherein the point of sale (100) provides wireless Internet connectivity to the portable communication device (110) during the purchase, and the portable communication device (110) communicates with the central server (180) using said Internet connectivity.

22. Method according to claim 12, wherein the point of sale (100) comprises automatic visual product inventory sensing means (106a,106b,106c), arranged to sense a presence of a product of at least one product type at the point of sale (100), which means (106a,106b,106c) are connected to a central computing unit (105) arranged to communicate sensed information to the central server (180).
